(19) United States
(12) Patent Application Publication
(10) Pub. No.: US 2011/0193261 A1
(43) Pub. Date: Aug. 11, 2011

(54) COMPRESSION MOLDING METHOD AND COMPRESSION MOLDING APPARATUS

(75) Inventors: Hiroshi Uragami, Kuse-gun (JP); Masanobu Takahashi, Kusatsu-shi (JP); Shigeru Hirata, Kusatsu-shi (JP)

(73) Assignee: TOWA CORPORATION, Kyoto-shi, Kyoto (JP)

(21) Appl. No.: 13/123,678

(22) PCT Filed: Oct. 16, 2009
(86) PCT No.: PCT/JP2009/005408

§ 371 Date: Apr. 11, 2011

(30) Foreign Application Priority Data
Oct. 20, 2008 (JP) 2008-269336

(51) Int. Cl. B29C 43/18; B29C 43/50

(52) U.S. Cl. 264/279; 425/234; 425/89

(57) ABSTRACT

The present invention aims at effectively decreasing the installation space of an entire semiconductor chip compression molding apparatus and effectively decreasing the clamping force in dies which are provided in the apparatus. It further aims at performing a clamping, in the case where substrates having a different thickness are used, with an efficient adjustment in accordance with the thicknesses of the substrates. To this end, the semiconductor chip compression molding includes two semiconductor chip compression molding dies (top and bottom dies), and a die opening/closing means for closing the die surfaces of top dies and those of bottom dies in each of the upper and lower dies. The die opening/closing means includes a die opening/closing mechanism having two racks and one pinion, and a thickness adjustment mechanism for adjusting the gaps in accordance with the thicknesses of the substrates supplied to each of the upper and lower dies.

### TECHNICAL FIELD

The present invention relates to an improved method and apparatus for compression-molding semiconductor chips mounted on a substrate with a resin material.

### BACKGROUND ART

Conventionally, a compression molding method is used to compression-mold semiconductor chips mounted on a substrate with a resin material. This method is performed in the following manner.

A semiconductor chip compression molding die (which is composed of a top die and a bottom die) is provided in a semiconductor chip compression molding apparatus. First, a substrate (insert member) on which semiconductor chips are mounted is supplied and set on a substrate setting unit provided in the top die, with the semiconductor-chip-mounting surface facing down. A resin material (e.g. a granular resin material) is supplied into a compression molding cavity provided in the bottom die (this cavity will be hereinafter referred to as a “bottom die cavity”) and heated to be melted, and then both the top die and the bottom die are clamped.

In this process, the semiconductor chips mounted on the substrate are immersed in the heated and melted resin material in the bottom die cavity.

Next, a cavity bottom member provided in the bottom of the bottom die cavity is moved upward to pressurize the resin in the bottom die cavity.

When a predetermined period of time required for curing has elapsed, the top and bottom dies are opened. Accordingly, it is possible to compression-mold (resin-seal) the semiconductor chips mounted on the substrate in a resin compact with a shape corresponding to that of the bottom die cavity, and it is possible to obtain a molded product (i.e. molded substrate) composed of a resin compact and a substrate.

### BACKGROUND ART DOCUMENT

### Patent Document

[Patent Document 1] JP-A 2007-307766

### DISCLOSURE OF THE INVENTION

### Problems to be Solved by the Invention

In compression-molding semiconductor chips mounted on a substrate by using a semiconductor chip compression molding apparatus (or a semiconductor chip compression molding die), there is a demand for efficiently enhancing the productivity of molded products.

One approach to meeting this demand is to compression-mold semiconductor chips mounted on a substrate by using a compression molding apparatus having a compression molding die in which two (or more) substrates are horizontally arranged on a die surface to efficiently increase the productivity of molded products.

However, this disadvantageously enlarges the entire compression molding apparatus. Supplying substrates to a compression molding die in which two substrates are horizontally arranged, for example, requires a large horizontal area for an in-loading mechanism.

Further, in recent years, a clean production environment has been required in semiconductor production plants. In such a plant, the horizontal installation space (occupied floor area) of a semiconductor-related production apparatus is limited.

The enlargement of a production apparatus is likely to increase the consumption energy of the apparatus as well as the energy to maintain the plant so as to meet the current requirement of cleaning the production environment, which adversely affects the productivity per unit area in the plant.

This raises the challenge of efficiently decreasing the installation space of the entire semiconductor chip compression molding apparatus.

Hence, in compression-molding two substrates for example, it is required to effectively decrease the installation space of a semiconductor chip compression molding apparatus.

In the case where a compression molding die in which two substrates are horizontally arranged on a die surface is clamped with the minimum clamping pressure, the required clamping force (energy) is, by a simple computation, approximately twice as high as the level required in the case where one substrate is clamped with the minimum clamping pressure.

That is, clamping a die with two substrates being horizontally arranged on the die surface requires a larger clamping force to the die.

This raises the challenge of efficiently decreasing the clamping force to the semiconductor chip compression molding die in compression-molding two substrates.

In order to solve the aforementioned problems, in the present invention, two semiconductor chip compression molding dies are vertically arranged in a semiconductor chip compression molding apparatus so as to provide the apparatus with a lower semiconductor chip compression molding die and an upper semiconductor chip compression molding die.

Therefore, in the present invention, compared to a compression molding die in which two substrates are horizontally arranged, the installation space of the dies can be decreased by the area of one substrate by a simple computation, which leads to an efficient decrease of the installation space of the compression molding apparatus (or die).

In addition, in the present invention, the dies in each of which one substrate can be set are vertically arranged. Hence, under the condition that each die should be clamped with the same clamping pressure in the case of the compression molding die in which two substrates are horizontally arranged, the dies needs only to be clamped with a clamping force that approximately equals the force required for clamping the die in which one substrate is set, which leads to an efficient decrease in the clamping force to the dies.

The clamping force according to the present invention can also be schematically explained as follows: In the present invention, the system for clamping (pressurizing) substrates is designed so that two substrates can be clamped with the minimum force, i.e. the force required for clamping one substrate; this is achieved by vertically arranging two compression molding dies, each of which is capable of compression-molding one substrate, in such a manner that the two substrates are arranged in the three-dimensional space and appear as a single substrate when viewed from above.

The present invention uses a semiconductor chip compression molding apparatus (compression molding method) having a lower semiconductor chip compression molding die and an upper semiconductor chip compression molding die. Therefore, it is required to efficiently clamp the lower semiconductor chip compression molding die and the upper semiconductor chip compression molding die.

In the case where a substrate is supplied to each of the two vertically arranged dies provided in the semiconductor chip compression molding apparatus and the dies are clamped, the supplied substrates may be different in thickness.

In such a case, a gap may be generated in one of the two dies, which causes a difficulty in efficiently clamping the two dies. Additionally, the substrate may be clamped with an excessive clamping force. The present invention aims at solving both these problems at the same time.

Therefore, in the present invention, when substrates with a different thickness are used, it is required to efficiently adjust the semiconductor chip compression molding apparatus (die) in accordance with the thicknesses of the substrates to clamp the dies.

That is, the present invention aims at providing a compression molding method and compression molding apparatus capable of effectively decreasing the installation space of the entire compression molding apparatus.

In addition, the present invention aims at providing a compression molding method and compression molding apparatus capable of effectively decreasing the clamping force in the compression molding apparatus (die).

Further, with respect to the configuration where two compression molding dies are arranged in a stacked fashion in a compression molding apparatus, the present invention aims at providing a compression molding method and a compression molding apparatus capable of effectively clamping the two compression molding dies.

In addition, with respect to the configuration where two compression molding dies are arranged in a stacked fashion in a semiconductor chip compression molding apparatus and where substrates (insert members) having a different substrate thickness are used, the present invention aims at a compression molding method and a compression molding apparatus capable of effectively adjusting and clamping the two compression molding dies provided in the semiconductor chip compression molding apparatus in accordance with the thicknesses of the substrates (insert members).

### Means for Solving the Problem

To solve the aforementioned technical problems, the present invention provides a compression molding method including the steps of:

a) individually supplying an insert member to each of two compression molding dies vertically arranged in a stacked fashion;

b) supplying an adequate amount of resin material to each of the two compression molding dies;

c) clamping each of the two compression molding dies; and

d) compression-molding, in each of the two compression molding dies, the insert member with the resin material to farm a molded product.

To solve the aforementioned technical problems, the present invention provides a compression molding method including the steps of:

a) individually supplying an insert member to an insert member setting unit provided in a top die of each of two compression molding dies vertically arranged in a stacked fashion each having the top die and a bottom die;

b) supplying an adequate amount of resin material to a compression molding cavity provided in the bottom die of each of the two compression molding dies and heating the resin material;

c) clamping the top die and the bottom die in each of the two compression molding dies; and

d) pressurizing the resin in the compression molding cavity in each of the two compression molding dies to compression-mold the insert members in the compression molding cavities.

To solve the aforementioned technical problems, the compression molding method according to the present invention may include the step of:

in clamping each of the two compression molding dies, moving the bottom die of the upper compression molding die by a distance of L and moving the bottom die of the lower compression molding die by a distance of 2L.

To solve the aforementioned technical problems, the compression molding method according to the present invention may include the step of:

in clamping each of the two compression molding dies, clamping them while a distance between a die surface of the top die and a die surface of the bottom die is adjusted in each of the two compression molding dies in accordance with a thickness of the insert member supplied to each of the two compression molding dies.

To solve the aforementioned technical problems, the compression molding method according to the present invention may include the steps of

covering the compression molding cavity in each of the two compression molding dies with a mold release film; and

supplying the resin material to each cavity which is covered with the mold release film and heating the resin material.

To solve the aforementioned technical problems, the present invention provides a compression molding apparatus for compression-molding an insert member with a resin material, having a molding unit including:

a) a stacked molding unit in which two compression molding dies each having a top die and a bottom die are vertically arranged in a stacked fashion; and

b) a die opening/closing means for opening/closing the two compression molding dies.

To solve the aforementioned technical problems, the present invention provides a compression molding apparatus, having a molding unit which includes:

a) an upper compression molding die and a lower compression molding die each having a top die and a bottom die and each being for compression-molding an insert member with a resin material, the upper compression molding die and the lower compression molding die being vertically arranged in a stacked fashion;

b) an upper fixed platen for fixing the upper top die;

c) a lower fixed platen provided beneath the upper fixed platen;

d) an adequate number of columns for connecting the upper fixed platen and the lower fixed platen;

e) an intermediate plate provided between the upper top die and the lower top die while fixing both of them, and vertically slidably mounted on one or more of the columns;

f) a slide plate vertically slidably mounted on one or more of the columns and for fixing the lower bottom die;

g) a die opening/closing means for individually closing a die surface of the top die and a die surface of the bottom die provided in each of the compression molding dies;

h) a pressure mechanism provided between the slide plate and the lower fixed platen, for applying a predetermined clamping pressure to the two compression molding dies from beneath the slide plate;

i) an insert member setting unit provided on each of the die surfaces of the top dies, on which the insert member can be supplied and set;

j) a compression molding cavity individually provided on the die surface of each of the bottom dies; and

k) a heater for heating the resin material supplied to the compression molding cavity.

To solve the aforementioned technical problems, in the compression molding apparatus according to the present invention, the die opening/closing means may include a die opening/closing mechanism having a rack and pinion mechanism composed of two racks and one pinion.

To solve the aforementioned technical problems, in the compression molding apparatus according to the present invention, the die opening/closing means may have a die opening/closing mechanism which includes:

a) a rack fixed to one of the columns;

b) an other rack fixed to a rack standing member vertically provided on the slide plate;

c) a pinion rotatably gear-engaged between the two racks;

d) a rotational shaft provided on the pinion;

e) a rotation mechanism for rotating the rotational shaft;

f) a bearing unit for rotatably supporting the rotational shaft; and

g) a pinion suspending member vertically suspended from the intermediate plate and having the bearing unit at a lower end thereof.

To solve the aforementioned technical problems, in the compression molding apparatus according to the present invention, the die opening/closing means may have a thickness adjustment mechanism for adjusting a distance between the die surface of the top die and the die surface of the bottom die of each of the upper compression molding die and the lower compression molding die, in accordance with a thickness of the insert member supplied to each of the upper and lower compression molding dies,

To solve the aforementioned technical problems, in the compression molding apparatus according to the present invention, the die opening/closing means may have a thickness adjustment mechanism which includes:

a) a bearing unit main body fixed to the pinion suspending member to which the other rack is fixed;

b) a slider hole formed in the bearing unit main body;

c) a bearing unit slider which vertically and elastically slides in the slider hole and rotatably supports the rotational shaft of the pinion; and

d) an elastic member for vertically and elastically sliding the slider in the slider hole.

To solve the aforementioned technical problems, in the compression molding apparatus according to the present invention, each of the two bottom dies may have a compression molding cavity having an inside covered with a mold release film.

### Effects of the Invention

In the present invention, a semiconductor chip compression molding apparatus (a semiconductor chip compression molding method) has a stacked molding mechanism in which two semiconductor chip compression molding dies are vertically arranged in a stacked fashion. Hence, compared to the configuration in which two semiconductor chip compression molding dies are horizontally arranged, the present invention can advantageously provide a compression molding method and a compression molding apparatus capable of effectively decreasing the installation space of the entire compression molding apparatus.

As previously described, in the present invention, the semiconductor chip compression molding apparatus (the semiconductor chip compression molding method) has a stacked molding mechanism in which two semiconductor chip compression molding dies are vertically arranged in a stacked fashion. Hence, compared to the configuration in which two semiconductor chip compression molding dies are horizontally arranged, the present invention can advantageously provide a compression molding method and compression molding apparatus capable of effectively decreasing the clamping force in the compression molding apparatus (dies).

In the present invention, the semiconductor chip compression molding apparatus (the semiconductor chip compression molding method) includes: a stacked molding mechanism in which two semiconductor chip compression molding dies are vertically arranged in a stacked fashion; and a rack and pinion mechanism composed of two racks and one pinion as the die opening/closing means (die opening/closing mechanism).

Therefore, in the case where two compression molding dies are arranged in a stacked fashion in a semiconductor chip compression molding apparatus, the present invention can advantageously provide a compression molding method and a compression molding apparatus capable of effectively clamping the two compression molding dies.

In addition, in the case where two compression molding dies are arranged in a stacked fashion in a semiconductor chip compression molding apparatus and where substrates (insert members) having different substrate thicknesses are used, the present invention can advantageously provide a compression molding method and a compression molding apparatus capable of effectively adjusting and clamping the two compression molding dies provided in the semiconductor chip compression molding apparatus in accordance with the thicknesses of the substrates (insert members).

### BRIEF DESCRIPTION OF THE DRAWINGS

FIG. 1 is a schematic plain view schematically showing the semiconductor chip compression molding apparatus according to the present invention.

FIG. 2 is a schematic front view schematically showing a stacked molding mechanism unit which is the main portion of the molding unit of the compression molding apparatus illustrated in FIG. 1, and illustrates the state in which the two semiconductor chip compression molding dies vertically arranged in the stacked molding mechanism unit are open.

FIG. 3 is a schematic front view schematically showing the stacked molding mechanism unit (two semiconductor chip compression molding dies) in the apparatus corresponding to that of FIG. 2, and illustrates the state in which the dies are closed.

FIG. 4 is a magnified schematic front view schematically showing the magnified main portion of the die illustrated in FIG. 3.

FIG. 5 is a magnified schematic vertical sectional view schematically showing the magnified main portion of the die illustrated in FIG. 3.

### BEST MODE FOR CARRYING OUT THE INVENTION

The present invention will be described in detail with reference to the figures of the embodiments.

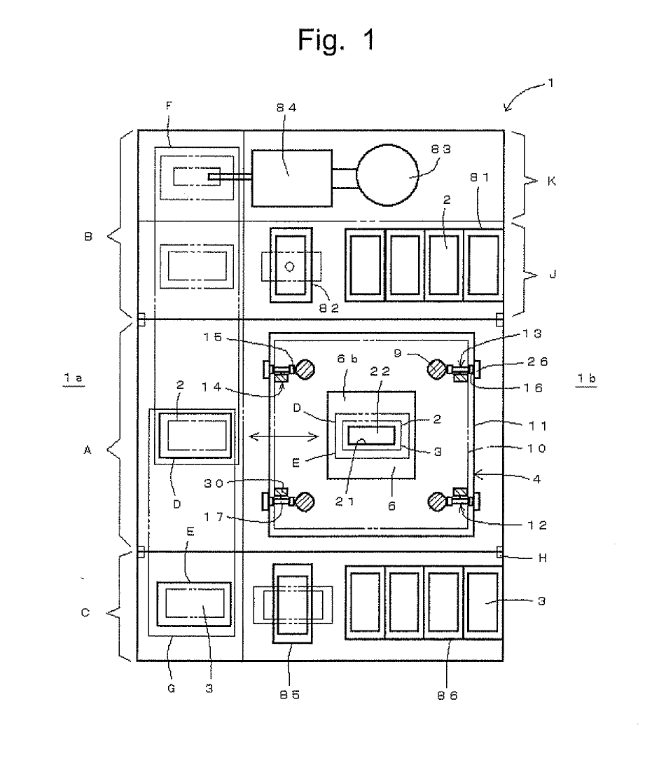

FIG. 1 shows a semiconductor chip compression molding apparatus according to the present invention.

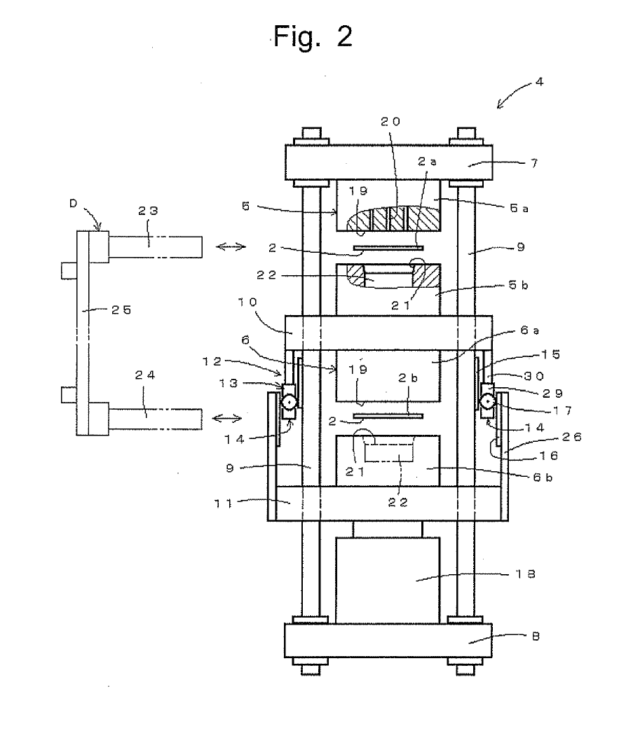

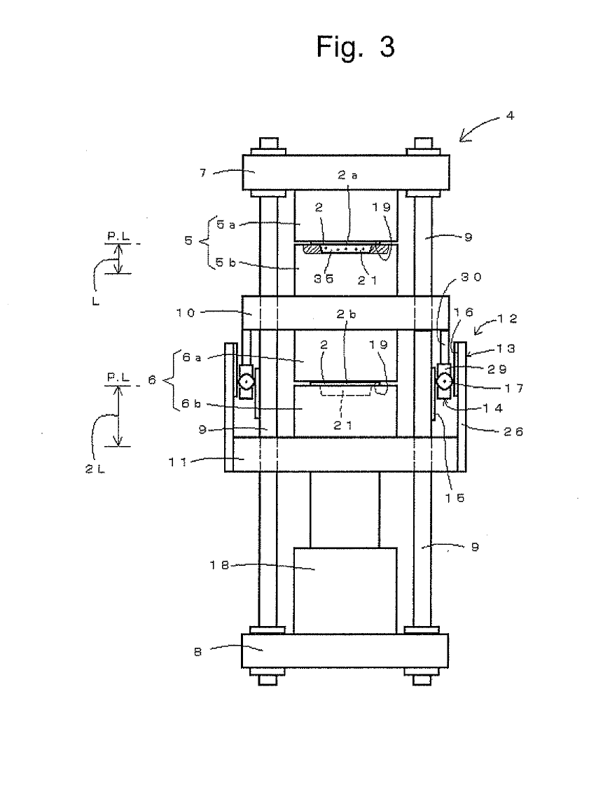

FIGS. 2 and 3 show a stacked molding mechanism unit (in which semiconductor chip compression molding dies are vertically arranged) in the apparatus illustrated in FIG. 1.

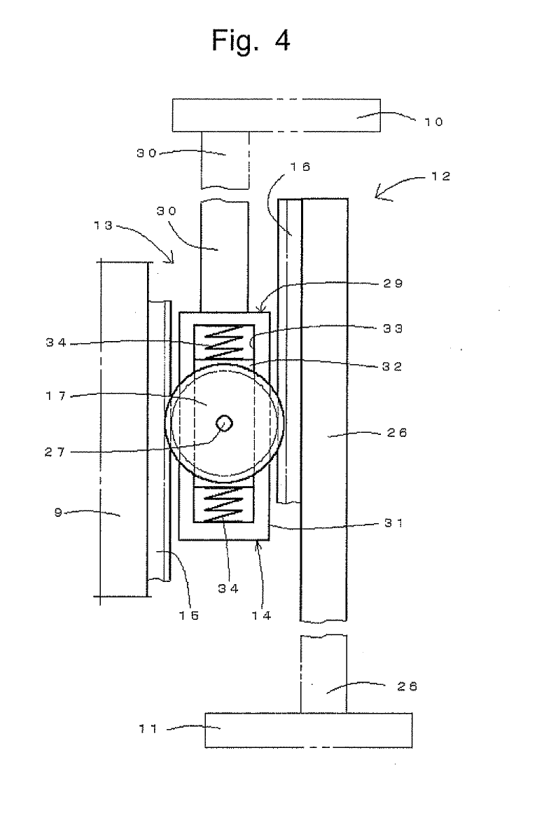

FIG. 4 shows a die opening/closing means (die opening/closing mechanism) in the stacked molding mechanism unit illustrated in FIG. 3.

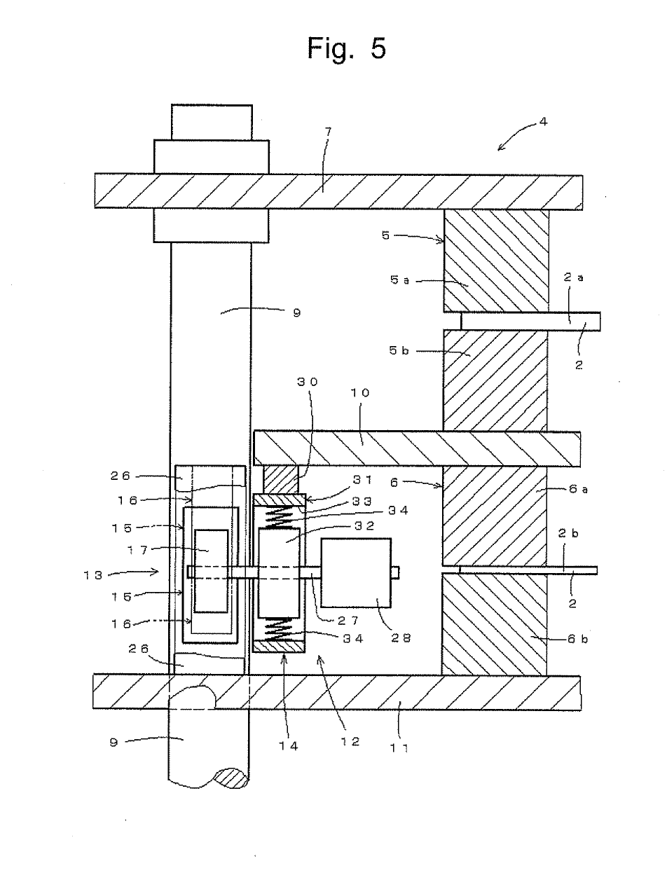

FIG. 5 shows a die opening/closing means (thickness adjustment mechanism) in the stacked molding mechanism unit illustrated in FIG. 3.

### (Configuration of the Semiconductor Chip Compression Molding Apparatus)

As shown in FIG. 1, a semiconductor chip compression molding apparatus 1 according to the present invention is composed of a molding unit A for compression-molding (or resin-sealing and molding), with a resin material, a substrate 2 (insert member) on which semiconductor chips are mounted; an in-loading unit B for supplying the substrate 2 (a substrate before molding) onto which semiconductor chips have been mounted in an in-loading mechanism D (or a mechanism for conveying a material before molding) and a resin material (e.g. a granular resin material) to the molding unit A; and an out-loading unit C for taking out and receiving a molded product 3 (the substrate 2 and a resin compact 35) which has been compression-molded in the molding unit A by an out-loading mechanism E (or a molded product conveying mechanism).

On the front side 1a of the molding apparatus 1, a moving area F of the in-loading mechanism D and a moving area G of the out-loading mechanism E are provided.

As illustrated in FIG. 1, with the in-loading mechanism D, the substrate 2 and the resin material are first supplied from the in-loading unit B to the molding unit A where the substrate 2 is compression-molded into a molded product 3. Then, with the out-loading mechanism E, the molded product 3 is taken out from the molding unit A and received in the out-loading unit C.

The in-loading unit B, the molding unit A, and the out-loading unit C are attachably and removably connected to each other in line in this order with unit connectors H.

### (Configuration of the Molding Unit)

As shown in FIG. 1, a stacked molding mechanism unit 4 (a molding apparatus which has a double layer structure) for compression-molding a substrate 2 on which semiconductor chips are mounted is provided on the back side 1b of the apparatus in the molding unit A.

Therefore, in the stacked molding mechanism unit (stacked die mechanism unit) 4, semiconductor chips mounted on the substrate 2 are compression-molded and a molded product (molded substrate) 3 can be faulted.

### (Configuration of the Stacked Molding Mechanism Unit)

As shown in FIGS. 2 and 3, in the stacked molding mechanism unit 4, two semiconductor chip compression molding dies are vertically provided in a stacked fashion.

That is, the stacked molding mechanism unit 4 includes an upper semiconductor chip compression molding die 5, which is located in the upper portion of the mechanism unit, and a lower semiconductor chip compression molding die 6, which is located in the lower portion of the mechanism unit.

The upper compression molding die 5 is composed of a top die 5a and a bottom die 5b which faces the top die 5a. The lower compression molding die 6 is composed of a top die 6a and a bottom die 6b which faces the top die 6a.

Therefore, in each of the two pairs of dies 5 and 6 (the top and bottom dies 5a and 5b, or the top and bottom dies 6a and 6b) vertically stacked in the stacked molding mechanism unit 4, a substrate 2 on which semiconductor chips are mounted can be individually (i.e. separately at each die) compression-molded with a granular resin material (granular resin) for example to form a molded product 3.

As will be described later, each of the upper compression molding die 5 and the lower compression molding die 6 (upper and lower dies 5 and 6) includes a top die substrate setting unit 19 and a compression molding bottom die cavity 21.

The stacked molding mechanism unit 4 includes an upper fixed platen 7 and a lower fixed platen 8 provided beneath the upper fixed platen 7. The upper fixed platen 7 and the lower fixed platen 8 are fixed to a predetermined number (four in the illustrated example) of columns (tie bars) 9.

Between the upper fixed platen 7 and the lower fixed platen 8, an intermediate plate (intermediate moving plate) 10 is vertically slidably mounted on the predetermined number of columns 9.

Between the intermediate plate 0 and the lower fixed platen 8, a slide plate (bottom moving plate) 11 is vertically slidably mounted on the predetermined number of columns 9 in the same manner as the intermediate plate 10.

The top die 5a of the upper die 5 is (immovably) attached onto the lower side of the upper fixed platen 7.

The bottom die 5b of the upper compression molding die 5 is attached onto the upper side of the intermediate plate 10. The top die 6a of the lower compression molding die 6 is attached onto the lower side of the intermediate plate 10.

The bottom die 6b of the lower die 6 is attached onto the upper side of the slide plate 11.

The upper bottom die 5b, the intermediate plate 10, and the lower top die 6a can be vertically moved integrally with each other.

The lower bottom die 6b and the slid plate 11 can be vertically moved integrally with each other.

As shown in FIGS. 2 and 3, the stacked molding mechanism unit 4 includes a die opening/closing means 12 for interlockingly and simultaneously opening or closing the die surface of the top die 5a and that of the bottom die 5b, and that of the top die 6a and that of the bottom die 6b in each of the upper compression molding die 5 and the lower compression molding die 6 (upper and lower dies 5 and 6), as will be described later.

Therefore, in the stacked molding mechanism unit 4, the intermediate plate 10 and the slide plate 11 can be individually moved upward by using the die opening/closing means 12 so that the die surface of the top die 5a and that of the bottom die 5b in the upper die 5 will be closed, whereby the top and bottom dies 5a and 5b can be clamped (refer to FIGS. 2 and 3).

At the same time, the die surface of the bottom die 6a and that of the bottom die 6b in the lower die 6 will also be closed, whereby the top and bottom dies 6a and 6b can be clamped.

In the illustrated example, there are four sets of the die opening/closing means 12 attached to the four columns 9, respectively.

As will be described later, the die opening/closing means 12 is composed of: a die opening/closing mechanism 13 for opening or closing the die surfaces of the top dies 5a and 6a and those of the bottom dies 5b and 6b in the upper and lower dies 5 and 6; and a thickness adjustment mechanism 14, which has a floating structure, for adjusting the thicknesses of two substrates 2 (2a and 2b) sandwiched between the die surfaces of the top dies 5a and 6a as well as between those of the bottom dies 5b and 6b.

As will be described later, a rack and pinion mechanism is used for the die opening/closing mechanism 13, which is composed of two racks and one pinion 17 gear-engaged between these two racks.

As will be described later, in the rack and pinion mechanism of the die opening/closing mechanism 13, one rack (column-side rack 15) is fixedly installed on the side of the column 9 and the other rack (slide-plate-side rack 16) is installed on the side of the slide plate 11. The pinion 17 which is gear-engaged between the two racks is installed on the side of the intermediate plate 10 (refer to FIG. 4).

As will be described later, in the case where the substrates 2 supplied to the upper and lower dies 5 and 6 have different thicknesses (e.g. a thick substrate 2a and thin substrate 2b shown in FIG. 5), the intermediate plate 15 (including the bottom die 5b and the top die 6a) is moved upward or downward due to the elasticity of the elastic member 34 in the thickness adjustment mechanism 14, whereby the thicknesses of the substrates 2 (2a and 2b) can be efficiently adjusted in each of the upper and lower dies 5 and 6.

Hence, as will be described later, the die surface of the top die 5a (6a) and that of the bottom die 5b (6b) can be closed to be clamped in each of the upper and lower dies 5 and 6, by rotating the pinion 17 to move the pinion 17 (and the intermediate plate 10) upward and move the slide-plate-side rack 16 (and the slide plate 11) upward in the die opening/closing means 12 (die opening/closing mechanism 13).

In this process, the pinion 17 (and the intermediate plate 10) is moved upward by distance L and the slide-plate-side rack 16 (and the slide plate 11) is moved upward by distance 2L.

The slide-plate-side rack 16 (and the slide plate 11) is moved by L relative to the pinion 17.

In this process, as will be described later, in each of the upper and lower dies 5 and 6, the distance between the die surface of the top die 5a and that of the bottom die 5b, and the distance between the die surface of the top die 6a and that of the bottom die 6b can be efficiently adjusted in accordance with the thicknesses of the substrates 2 (2a and 2b) by the thickness adjustment mechanism 14.

Provided between the slide plate 11 and the lower fixed platen 8 is a pressure mechanism 18 (slide plate vertical pressure mechanism) for pressing the upper and lower dies 5 and 6 on each other with a predetermined clamping pressure (predetermined clamping force) in clamping the upper and lower dies 5 and 6 by the die opening/closing means 12 (when they are clamped by the stacked molding mechanism 4).

Therefore, in the stacked molding mechanism 4 (upper and lower dies 5 and 6), each of the upper and lower dies 5 and 6 can be individually clamped by closing the die surfaces by the die opening/closing means 12 (die opening/closing mechanism 13), and each of the upper and lower dies 5 and 6 can be individually pressed on each other with a predetermined clamping pressure (clamping force) by the pressure mechanism 18.

In addition, in clamping the upper and lower dies 5 and 6 by the die opening/closing means 12 (die opening/closing mechanism 13), the slide plate 11 can be supplementarily moved upward or downward by the pressure mechanism 18.

Hence, each of the upper and lower dies 5 and 6 can be clamped with a predetermined clamping pressure by the die opening/closing means 12 (die opening/closing mechanism 13) and the pressure mechanism 18.

### (Effects of Stacking the Dies in the Stacked Molding Mechanism Unit)

In the present invention, the stacked molding mechanism unit 4 in which two compression molding dies 5 and 6 are vertically stacked is provided in the semiconductor chip compression molding apparatus 1 (molding unit A).

Hence, the semiconductor chip compression molding apparatus 1 according to the present invention practically has the configuration of a semiconductor chip compression molding die for one horizontally-placed substrate.

Therefore, compared to a semiconductor chip compression molding apparatus in which a compression molding die for two horizontally-placed substrates is provided, the present invention can effectively decrease the installation space of the entire apparatus.

In the semiconductor chip compression molding apparatus 1 according to the present invention, two semiconductor chip compression molding dies 5 and 6 are stacked. Such a configuration is practically equivalent to a semiconductor chip compression molding die (apparatus 1) in which one horizontally-placed substrate is clamped with a predetermined clamping pressure.

Therefore, compared to a semiconductor chip compression molding apparatus in which a compression molding dies for two horizontally-placed substrates is provided, the present invention can effectively reduce the clamping force in the compression molding apparatus 1 (dies 5 and 6) according to the present invention.

### (Configuration of the Upper and Lower Compression Molding Dies)

The upper compression molding die 5 and the lower compression molding die 6 in the stacked molding mechanism unit 4 in the present invention will be described.

Each of the upper compression molding die 5 and the lower compression molding die 6 (each of the upper and lower dies 5 and 6) has the same die configuration.

As shown in FIGS. 2 and 3, a substrate setting unit 19 (insert member setting unit) of the top die 5a for supplying a substrate 2 with semiconductor chips mounted on the downward-directed side, and suction holes 20 (substrate suction means) as a substrate fixing means for fixing the substrate 2 (2a or 2b) on the substrate setting unit 19, are provided on the die surface of the top die of the upper compression molding die 5.

As shown in FIGS. 2 and 3, a compression molding cavity 21 of the bottom die 5b with an upwardly-open opening and a cavity bottom member 22 for pressurizing resin provided on the bottom of the bottom die cavity 21 are provided on the die surface of the bottom die 5b of the lower compression molding die 5.

Although not shown, a heater for heating the upper compression molding die 5 to a predetermined temperature is provided in the die 5.

In the in-loading mechanism D, the substrate 2 on which semiconductor chips are mounted is supplied and set on the substrate setting unit 19 of the top die 5a and air is forcedly sucked from the suction holes provided on the die surface of the top die 5a, whereby the substrate 2 can be fixed by suction onto the substrate setting unit 19.

In the in-loading mechanism D, a predetermined amount of resin material (granular resin) is supplied into the bottom die cavity 21 to be heated and melted.

Hence, by clamping the upper compression molding die 5 (the top and bottom dies 5a), the semiconductor chips mounted on the substrate 2 which has been supplied and set on the substrate setting unit 19 of the top die are immersed in the resin material which has been heated and melted in the bottom die cavity 21, and simultaneously a predetermined resin pressure is applied to the resin in the bottom die cavity 21 by the cavity bottom member 22.

Accordingly, in the bottom die cavity 21, semiconductor chips are compression-molded (sealed and molded with resin) in a resin compact 35 with a shape corresponding to that of the bottom die cavity 21, and a molded product 3 (the resin compact 35 and the substrate 2) can be formed by the upper compression molding die 5.

Similar to the upper compression molding die 5, the lower compression molding die 6 also has a substrate setting unit 19 provided on the top die 6a, a compression molding cavity 21 provided on the bottom die 6b, a cavity bottom member 22, and a heater (not shown).

Hence, in the lower compression molding die 6, as in the upper compression molding die 5, semiconductor chips mounted on a substrate 2 are compression-molded (sealed and molded with resin) in a resin compact 35 with a shape corresponding to that of the bottom die cavity 21, whereby a molded product 3 (the resin compact 35 and the substrate 2) can be formed,

### (Configuration of the In-Loading Mechanism)

As shown in FIG. 2, the in-loading mechanism D is composed of, for example, an upper in-loading unit 23, a lower in-loading unit 24 provided beneath the upper in-loading unit 23, and an in-loading connector 25 for connecting the upper in-loading unit 23 and the lower in-loading unit 24.

As shown in FIG. 1, the in-loading mechanism D can reciprocate between the in-loading unit B and the molding unit A along the in-loading mechanism moving area F.

In the in-loading unit B, a substrate 2 and a resin material (granular resin) can be fastened (or placed) to be individually set to each of the upper in-loading unit 23 and the lower in-loading unit 24.

That is, first, in the in-loading unit B, the substrate 2 and the resin material are individually fastened and set to each of the upper in-loading unit 23 and the lower in-loading unit 24 in the in-loading mechanism D, and the in-loading mechanism D can be moved from the in-loading unit B to the molding unit A along the in-loading mechanism moving area F.

Next, in the stacked molding mechanism unit 4 in the molding unit A, the upper in-loading unit 23 can be made to enter the upper die 5 (into the space between the top and bottom dies 5a and 5b).

At the same time, the lower in-loading unit 24 can be made to enter the lower die 6 (into the space between the top and bottom dies 6a and 6b).

Accordingly, in the upper die 5, the substrate 2 can be supplied and set on the substrate setting unit 19 of the top die 5a and the resin material can be supplied into the cavity 21 of the bottom die 5b by the upper in-loading unit 23.

At this point in time, in the lower die 6, the substrate 2 can be supplied and set on the substrate setting unit 19 of the top die 6a and the resin material can be supplied into the cavity 21 of the bottom die 6b by the lower in-loading unit 24.

### (Configuration of the Out-Loading Mechanism)

Although not shown, the out-loading mechanism E is composed of, (similar to the in-loading mechanism D), an upper out-loading unit, a lower out-loading unit provided beneath the upper out-loading unit, and an out-loading connector for connecting the upper out-loading unit and the lower out-loading unit, for example.

As shown in FIG. 1, the out-loading mechanism E can reciprocate between the out-loading unit C and the molding unit A along the out-loading mechanism moving area G.

In the out-loading unit C, each molded product 3 can be taken out and received individually from the upper out-loading unit and the lower out-loading unit.

That is, first, in the stacked molding mechanism unit 4 in the molding unit A, the upper out-loading unit can be made to enter the space between the upper top and bottom dies 5a and 5b to take out (by fastening) the molded product 3 from the die surface of the bottom die 5b.

At the same time, the lower out-loading unit can be made to enter the space between the lower top and bottom dies 6a and 6b to take out (by fastening) the molded product 3 from the die surface of the bottom die 6b.

Next, the out-loading mechanism unit E can be moved from the molding unit A to the out-loading unit C along the out-loading mechanism moving area G.

Subsequently, in the out-loading unit C, each molded products 3 can be taken out and received individually from the upper out-loading unit and the lower out-loading unit of the out-loading mechanism E.

### (Configuration of the Die Opening/Closing Means)

As previously described, the die opening/closing means 12 is composed of the die opening/closing mechanism 13 for individually opening or closing the upper and lower dies 5 and 6 and the thickness adjustment mechanism 14 for performing an adjustment corresponding to the thicknesses of the substrates 2 which are individually clamped (sandwiched) by the upper and lower dies 5 and 6.

Therefore, by using the die opening/closing means 12, each of the upper and lower dies 5 and 6 can be individually clamped by the die opening/closing mechanism 13, and the thicknesses of the substrates 2 sandwiched by the upper and lower dies 5 and 6 can be individually adjusted by the thickness adjustment mechanism 14.

### (The Die Opening/Closing Mechanism in the Die Opening/Closing Means)

As shown in FIGS. 4 and 5, in the die opening/closing mechanism 13 of the die opening/closing means 12, a column-side lack 15 is vertically fixed to a predetermined position of the column 9 between the intermediate plate 10 and the slide plate 11.

In the die opening/closing mechanism 13, the slide-plate-side rack 16 is vertically fixed to a predetermined position of the rack standing member 26 vertically installed on the slide plate 11.

The pinion 17 is provided between the column-side rack 15 and the side-plate-side rack 16 in such a manner as to be gear-engaged to these two racks.

In the die opening/closing mechanism 13, a rotational shaft 27 coaxially fixed to the pinion 17, and a rotation mechanism 28 such as a motor is connected to the rotational shaft 27.

Hence, the pinion 17 can be rotated in the forward or backward direction by the rotation mechanism 28 through the rotational shaft 27.

Provided between the pinion 17 and the rotation mechanism 28 is a bearing unit 29 (including the thickness adjustment mechanism 14 which will be described later), which has a floating structure, for rotatably supporting the rotational shaft 27.

In the die opening/closing mechanism 13, a pinion suspending member 30 is suspended from the intermediate plate 10, and the bearing unit 29, in which the pinion 17 (rotational shaft 27) is rotatably provided, is fixedly provided at the lower end of the pinion suspending member 30.

Next, the opening/closing operation of the die opening/closing mechanism 13 (rack and pinion mechanism) will be described with reference to FIGS. 2 through 5.

First, the operation of clamping the upper and lower dies 5 and 6 is described. In the example illustrated in FIG. 4, the counterclockwise direction on the figure is the normal direction. When rotated in the normal direction in the state of being engaged with the column-side rack 15 fixed to the column 9, the pinion 17 moves upward.

Hence, the pinion 17, the pinion suspending member 30, and the intermediate plate 10 can be integrally moved (or pushed) upward (refer to FIG. 5).

At the same time, the slide-plate-side rack 16 fixed to the rack standing member 26 (slide plate 11) can be moved (or pulled) upward by the pinion 17 rotating in the normal direction and moving upward.

Accordingly, the rack standing member 26, the slide-plate-side rack 16 and the slide plate 11 can be integrally moved upward.

In the example illustrated in FIG. 4, the clockwise direction on the figure is the reverse direction. When rotated in the reverse direction in the state of being engaged with the column-side rack 15, the pinion 17 moves downward.

Hence, the pinion 17, the pinion suspending member 30, and the intermediate plate 10 can be integrally moved downward.

At the same time, the slide-plate-side rack 16 fixed to the rack standing member 26 (slide plate 11) can be moved downward by the pinion 17 rotating in the reverse direction and moving downward.

Accordingly, the rack standing member 26, the slide-plate-side rack 16 and the slide plate 11 can be integrally moved downward.

That is, by rotating the pinion 17 in the normal or reverse direction by the rotation mechanism 28 (rotational shaft 27) in the die opening/closing mechanism 13, the intermediate plate 10 and the slide plate 11 can be interlockingly and simultaneously moved upward or downward.

Accordingly, in each of the upper and lower dies 5 and 6, the die surfaces of the top dies 5a and 6a and those of the bottom dies 5b and 6b can be individually closed.

### (Moving Distance by the Die Opening/Closing Mechanism)

The moving distance (stroke) of the intermediate plate 10 and the moving distance (stroke) of the slide plate 11 by the die opening/closing mechanism 13 which uses a rack and pinion mechanism will be described (with reference to FIG. 3).

For example, if the pinion 17 is rotated in the normal direction by (arc) distance L along the circumference (for a given period of time), the pinion 17 which rotates along the arc (distance) L is moved upward along the column-side rack 15 by the same distance L.

Hence, the die surface of the bottom die 5b installed on the intermediate plate 10 fixed to the pinion 17 through the pinion suspending member 30 is moved upward by distance L.

At the same time, the slide-plate-side rack 16 fixed to the rack standing member 26 is moved upward by distance L relative to the position of the pinion 17.

That is, the die surface of the bottom die 6b installed on the slide plate 11 is moved upward by distance L relative to the pinion 17.

Therefore, the slide-plate-side rack 16 fixed to the rack standing member 26 is practically moved upward by distance 2L, the sum of the distance L by which the pinion 17 is moved upward along the column-side rack 15 and the distance L by which the slide-plate-side rack 16 itself is moved relative to the pinion 17.

Accordingly, when the intermediate plate 10 (and the pinion 17) is moved upward by distance L, the slide plate 11 (and the slide-plate-side rack 16) is moved upward by distance 2L.

At the same time, as a matter of course, the die surface of the bottom die 5b of the upper die 5 can be moved upward by distance L, and the die surface of the bottom die 6b of the lower die 6 can be moved upward by distance 2L.

The operation of opening the upper and lower dies 5 and 6 by the die opening/closing mechanism 13 is similar to the previously described clamping operation.

That is to say, when the intermediate plate 10 (and the pinion 17) is moved downward by distance L, the slide plate 11 (and the slide-plate-side rack 16) is moved downward by distance 2L.

### (Thickness Adjustment Mechanism of the Die Opening/Closing Means)

As previously described, the bearing unit 29 includes the thickness adjustment mechanism 14 having a floating structure.

The thickness adjustment mechanism 14 is composed of: a bearing unit main body 31; a bearing unit slider 32 which receives the rotational shaft 27; and a slider hole 33 of the bearing unit main body for sliding the slider 32 upward or downward.

In the thickness adjustment mechanism 14 and inside the slider hole 33 of the main body, an elastic member 34 such as a compression spring for elastically sliding the slider 32 upward or downward is provided above and below the slider 32, respectively.

Hence, in the slider hole 33 of the main body, the slider 32 can be elastically slid upward or downward by the elastic members 34.

In the slider hole 33 in the main body 31 of the bearing unit, the slider 32 including the pinion 17 and the rotational shaft 27 can be slid (floated) upward or downward by the elasticity of the elastic members 34.

That is, in the case where two substrates 2 (2a and 2b) having different substrate thicknesses are individually supplied and set to each of the upper and lower dies 5 and 6 and clamped by the die opening/closing mechanism 13 of the opening/closing means 12, the two substrates 2 (2a and 2b) having different thicknesses can be efficiently and individually sandwiched by the die surfaces in accordance with their different thicknesses by the thickness adjustment mechanism 14 (refer to FIG. 5).

Hence, by using the thickness adjustment mechanism 14, it is possible to efficiently and individually adjust the distances (interspaces) between the die surfaces in accordance with two substrates 2 (2a and 2b) having different thicknesses.

Therefore, in clamping the upper and lower dies 5 and 6 in the stacked molding mechanism unit 4, it is possible to efficiently prevent the formation of a gap between the die surface (bottom die surface) and the substrate 2 (the surface on which semiconductor chips are mounted) in each of the upper and lower dies 5 and 6.

In addition, in clamping the upper and lower dies 5 and 6, it is possible to efficiently prevent an excess clamping pressure from being applied to the substrate 2 in each of the upper and lower dies 5 and 6.

### (Effect of Adjusting the Substrate Thickness by the Thickness Adjustment Mechanism)

The operation of adjusting the distance between the die surface of the top die 5a and that of the bottom die 5b and the distance between the die surface of the top die 6a and that of the bottom die 6b for the substrates by the thickness adjustment mechanism 14 will be described with reference to FIG. 5.

FIG. 5 illustrates an example in which a thicker substrate 2a (2) is clamped in the upper die 5 and a thinner substrate 2b (2) is clamped, in the lower die 6.

As shown in FIG. 5, when a clamping is performed by the stacked molding mechanism unit 4, the upper fixed platen 7 (including the upper top die 5a), the column 9, and the column-side rack 15 are united in a fixed state, forming a column-side group.

In addition, when a clamping is performed by the stacked molding mechanism unit 4, the intermediate plate 10 (including the upper bottom die 5b and the lower top die 6a), the pinion suspending member 30, and the main body 31 of the bearing unit 29 having the slider hole 33 are united in a fixed state, forming an intermediate-plate-side group.

Further, when a clamping is performed by the stacked molding mechanism unit 4, the slide plate 11 including the lower bottom die 6b, the rack standing member 26, the slide-plate-side rack 16, the pinion 17, and the slider 32 including the rotational shaft 27 (rotation mechanism 28) are united in a fixed state, forming a slide-plate-side group.

Therefore, by the elastic members 34 of the thickness adjustment mechanism 14, the intermediate-plate-side group can be moved upward or downward between the column-side group and the slide-plate-side group.

Hence, by adjusting the distance between the die surface of the top die 5a and that of the bottom die 5b and the distance between the die surface of the top die 6a and that of the bottom die 6b in accordance with the thicknesses of the substrates 2 (2a and 2b) by the thickness adjustment mechanism 14, the two substrates 2 (2a and 2b) having different substrate thicknesses can be individually and effectively sandwiched and clamped between the die surface of the top die 5a of the column-side group and that of the bottom die 5b of the intermediate-plate-side group or between the die surface of the top die of the intermediate-plate-side group and that of the bottom die of the slide-plate-side group.

In other words, in clamping the upper and lower dies 5 and 6 in the stacked molding mechanism unit 4, when the clamping is adjusted in accordance with the thicknesses of the substrates 2 (2a and 2b), the column-side group (column-side rack 15) and the slide-plate-side group (slide-plate-side rack 16) are fixed through the pinion 17 (the slider 32 including the rotational shaft 27), and the adjustment can be performed while the intermediate-plate-side group between the column-side group and the slide-plate-side group is elastically moved upward or downward (in an elastically cushioned state) by the elastic member 34.

### (Clamping a Thick Substrate and a Thin Substrate)

The case of supplying a thick substrate 2a to the upper die 5 (the substrate setting unit 19 of the top die 5a) and a thin substrate 2b to the lower die 6 (the substrate setting unit 19 of the top die 6a) will be described with reference to FIG. 5.

In the case of clamping the upper and lower dies 5 and 6 in the stacked molding mechanism unit 4, when the pinion 17 is rotated in the normal direction as previously described, the pinion 17 (and the intermediate plate 10) rotating in the normal direction moves upward along the column-side rack 15 the distance L, and the slide-plate-side rack 16 (and the slide-plate 11) is moved upward by distance L by the rotating and upward-moving pinion 17. Thus, in each of the upper and lower dies 5 and 6, the die surfaces can be closed at an equal clamping velocity.

That is, in the upper die 5, the thick substrate 2a supplied and set on the substrate setting unit 19 of the top die 5a is first sandwiched between the die surfaces of the top and bottom dies 5a and 5b.

At this point in time, in the lower die 6, there is a gap between the lower surface (the surface on which semiconductor chips are mounted) of the thin substrate 2b supplied on the substrate setting unit 19 of the top die 6a and the die surface of the bottom die 6b.

Then, by further rotating the pinion 17 in the normal direction, the thin substrate 2b supplied and set on the substrate setting unit 19 of the top die 6a is sandwiched between the die surfaces of the top and bottom dies 6a and 6b in the lower die 6.

Regarding the slide plate 11 (the die surface of the lower bottom die 6b) and the intermediate plate 10 (the die surface of the upper bottom die 5b), at this point in time, even if the slide plate 11 is further moved upward, the slider 32 which is substantially fixed to the slide plate 11 is elastically moved upward against the elastic member 34 in the slider hole 33 of the main body. Accordingly, the slider 32 can be elastically buffered by the elastic members 34 (the thickness adjustment mechanism 14).

Therefore, by the thickness adjustment mechanism 14, the distance between the die surface of the top die 5a and that of the bottom die 5b, and the distance between the die surface of the top die 6a and that of the bottom die 6b, can be efficiently adjusted in correspondence to the thicknesses of the thick substrate 2a and the thin substrate 2b.

### (Configuration of the In-Loading Unit)

As shown in FIG. 1, the in-loading unit B is composed of, for example, a substrate supply mechanism unit J and a resin material supply mechanism unit K.

As shown in FIG. 1, the substrate supply mechanism unit J is composed of, for example, a substrate loading unit (stocker) 81, and a substrate alignment unit 32 for aligning substrates 2 from the substrate loading unit 81 in a predetermined direction and for supplying and setting them into the in-loading mechanism D (the upper in-loading unit 23 and the lower in-loading unit 24).

Therefore, substrates 2 from the substrate loading unit 81 can be aligned in a predetermined direction by the substrate alignment unit 82, and the aligned substrates 2 can be individually fastened, placed, and set into the upper in-loading unit 23 and the lower in-loading unit 24.

As shown in FIG. 1, the resin material supply mechanism unit K is composed of, for example, a resin material loading unit 83 for loading a resin material (e.g. a granular resin) and a resin material distribution unit 84 for distributing the resin material (granular resin) from the resin material loading unit to the in-loading mechanism D (the upper in-loading unit 23 and the lower in-loading unit 24) while leveling the resin material.

Hence, the granular resin from the resin material loading unit 83 can be, supplied, distributed and leveled (in a resin container, for example) by the resin material distribution unit 84, and a predetermined amount of leveled resin material can be fastened, placed, and set individually to the upper in-loading unit 23 and the lower in-loading unit 24.

### (Configuration of the Out-Loading Unit)

As shown in FIG. 1, the out-loading unit (molded product containing mechanism unit) C is composed of, for example, a molded product placing unit 85 for placing molded products 3 from the out-loading mechanism E (the upper out-loading unit and the lower out-loading unit), and a molded product containing unit 86 (stocker) for containing the molded products 3 from the molded product placing unit.

Therefore, the molded products 3 placed in the molded product placing unit 85 can be transferred from the out-loading mechanism E (the upper out-loading unit and the lower out-loading unit) into the molded product containing unit 86.

### (Semiconductor Chip Compression Molding Method in the Present Invention)

As shown in FIG. 1, a substrate 2 and a resin material (e.g. a granular resin) are fastened and set in the in-loading mechanism D by the in-loading unit B, and the in-loading mechanism D is made to move from the in-loading unit B the molding unit A along the moving area F of the in-loading mechanism D.

Next, as shown in FIG. 2, the upper in-loading unit 23 of the in-loading mechanism D is made to enter the space between the top and bottom dies 5a and 5b of the upper die 5 in the stacked molding mechanism unit 4 in the molding unit A so that the substrate 2 on which semiconductor chips are mounted is supplied to the substrate setting unit 19 of the top die 5a. At the same time, a predetermined amount of leveled granular resin is supplied into the bottom die cavity 21 and then heated to be melted.

As in the upper die 5, the lower in-loading unit 24 of the in-loading mechanism D is made to enter the space between the top and bottom dies 6a and 6b of the lower die 6 so that the substrate 2 on which semiconductor chips are mounted is supplied on the substrate setting unit 19 of the top die 6a. At the same time, a predetermined amount of leveled granular resin is supplied into the bottom die cavity 21 and then heated to be melted.

Subsequently, the in-loading mechanism D is withdrawn and a clamping is performed in each of the upper and lower dies 5 and 6 in the stacked molding mechanism unit 4 by the die opening/closing means 12 (the die opening/closing mechanism 13) and the pressure mechanism 18. That is, the die surfaces of each of the upper and lower dies 5 and 6 (top and bottom dies 5a, 5b, 6a, and 6b) are individually closed.

At this point in time, the upper and lower dies 5 and 6 can be individually clamped with a predetermined clamping pressure by the pressure mechanism 18.

At the same time, by the thickness adjustment mechanism 14 in the die opening/closing means 12, each of the substrates 2 (2a and 2b) can be sandwiched and effectively clamped between the die surfaces in each of the upper and lower dies 5 and 6 in accordance with the thickness of each of the substrates 2 (2a and 2h) supplied respectively in the upper and lower dies 5 and 6, while the intermediate plate 10 is elastically moved upward or downward (in an elastically buffered state).

Simultaneously, in each of the upper and lower dies 5 and 6, the semiconductor chips mounted on the substrates 2 can be immersed in the resin material heated and melted in the bottom die cavity 21.

Then, in each of the upper and lower dies 5 and 6, the resin in the bottom die cavity 21 can be pressurized with a predetermined resin pressure by the cavity bottom member 22,

When a predetermined period of time required for curing has elapsed, each of the upper and lower dies 5 and 6 is individually opened. As a result, a molded product 3, in which the semiconductor chips mounted on the substrates 2 are individually compression-molded in the resin compact 35 with a shape corresponding to that of the bottom die cavity 21, is obtained in each of the upper and lower dies 5 and 6.

Then, the upper out-loading unit of the out-loading mechanism E is made to enter the space between the top and bottom dies 5a and 5b in the upper die 5 to take out the molded product 3 from the die surface of the bottom die 5b.

As in the upper die 5, the lower out-loading unit of the out-loading mechanism E is made to enter the space between the top and bottom dies 6a and 6b in the lower die 6 to take out the molded product 3 from the die surface of the bottom die 6b.

Then, the out-loading mechanism E is withdrawn and made to move from the molding unit A to the out-loading unit C along the moving area G for the out-loading mechanism E. In the out-loading unit C, the molded products 3 can be received,

### (Effects of the Present Invention)

According to the present invention, it is possible to create a semiconductor chip compression molding apparatus 1 including a stacked molding mechanism unit 4 in which two semiconductor chip compression molding dies 5 and 6 are vertically stacked.

Therefore, according to the present invention, the installation space of the entire semiconductor chip compression molding apparatus can be effectively decreased as compared to a semiconductor chip compression molding apparatus in which two compression molding dies are horizontally arranged.

In addition, since the semiconductor chip compression molding apparatus 1 according to the present invention has the configuration in which two semiconductor chip compression molding dies 5 and 6 are stacked, the clamping force in the semiconductor chip compression molding apparatus 1 (dies 5 and 6) can be effectively decreased, compared to the semiconductor chip compression molding apparatus (die) in which two compression molding dies are horizontally arranged.

With the present invention, in the configuration where two compression molding dies 5 and 6 are vertically stacked in a compression molding apparatus, the two upper and lower compression molding dies 5 and 6 can be efficiently clamped by the die opening/closing means 12 which uses a rack and pinion mechanism.

When the bottom die 5b of the upper compression molding die 5 (and the intermediate plate 10) is moved upward by distance L to clamp the dies, the bottom die 6b of the lower compression molding die 6 (and the slide plate 11) can be moved upward by a distance 2L to clamp the dies.

In the lower compression molding die 6, the relative distance with respect to the intermediate plate 10 is L.

With the present invention, in the case where two substrates 2 (2a and 2b) having different substrate thicknesses, the distance between the die surface of the top die 5a and that of the bottom die 5b, and the distance between the die surface of the top die 6a and that of the bottom die 6b can be efficiently adjusted to perform a clamping in accordance with the thicknesses of the substrates 2.

It should be noted that the present invention is not limited to previously-described embodiment, and can be arbitrarily and appropriately changed or selected according to necessity without any departure from the scope of the present invention.

In the previously-described embodiment, a mold release film for coating (by suction) the bottom die cavity 21 for compression molding may be used.

For example, in the previously-described embodiment, a leveled granular resin may be supplied into the bottom die cavity 21 covered with the mold release film, and the resin may be heated and melted. Then, the semiconductor chips mounted on a substrate may be compression-molded.

In the case where the bottom die cavity 21 is covered with the mold release film, an intermediate die may be provided between the top and bottom dies so that the mold release film is held between the bottom die and the intermediate die.

Although a rack and pinion mechanism is used as the die opening/closing means 12 (die opening/closing mechanism 13) in the aforementioned embodiment, it is also possible to use, for example, a linkage mechanism, a belt-pulley transmission mechanism, or a hydraulic transmission mechanism.

In the previously-described embodiment, the in-loading unit B, the molding unit A, and the out-loading unit C are attachably and removably connected to each other in line in this order. However, the three kinds of units A, B, and C can be attachably and removably connected to each other in line in any order.

In the in-loading unit B, the substrate supply mechanism unit J can be separated as a substrate supply unit, and the resin material supply mechanism unit K can be separated as a resin material supply unit.

In this case, the substrate supply unit (J), the resin material supply unit (K), the out-loading unit C, and the molding unit A can be attachably and removably connected to each other in line in any order.

In the previously-described embodiment, the substrate 2 and the resin material are simultaneously conveyed to the stacked molding mechanism unit 4 by the in-loading mechanism D (or a mechanism for conveying a material before molding). However, in the aforementioned embodiment, the substrate 2 and the resin material may be separately conveyed to the stacked molding mechanism unit 4 by separate conveying mechanisms (loaders).

In the previously-described embodiment, the conveyance of the substrate 2 before molding to the stacked molding mechanism 4 and the takeout of the molded product 3 from the stacked molding mechanism 4 can be performed by the same conveying mechanism (loader).

In the previously-described embodiment, any required number of molding units may be attachably and removably connected to each other in line between the in-loading unit and the out-loading unit.

On one side of the configuration in which a required number of molding units A are attachably and removably connected to each other in line, the in-loading unit B and the out-loading unit C may be attachably and removably connected to each other in line in any order.

Accordingly, as previously described, by using the configuration in which a required number of molding units A are attachably and removably connected to each other in line, the productivity of molded products which are compression-molded in the molding unit A can be efficiently improved.

In the previously-described embodiment, a liquid resin material, a powdery resin material may be used in place of a granular resin material.

### EXPLANATION OF NUMERALS

1 . . . Semiconductor Chip Compression Molding Apparatus
1a . . . Front Side of the Apparatus
1b . . . Back Side of the Apparatus
2 . . . Substrate (Pre-Molded Substrate)
2a . . . Thick Substrate
2b . . . Thin Substrate
3 . . . Molded Product (Molded Substrate)
4 . . . Stacked Molding Mechanism Unit
5 . . . Upper Compression Molding Die
5a . . . Top Die
5b . . . Bottom Die
6 . . . Lower Compression Molding Die
6a . . . Top Die
6b . . . Bottom Die
7 . . . Upper Fixed Platen
8 . . . Lower Fixed Platen
9 . . . Column
10 . . . Intermediate Plate
11 . . . Slide Plate
12 . . . Die Opening/Closing Means
13 . . . Die Opening/Closing Mechanism
14 . . . Thickness Adjustment Mechanism
15 . . . Column-Side Rack
16 . . . Slide-Plate-Side Rack
17 . . . Pinion
18 . . . Pressure Mechanism
19 . . . Substrate Setting Unit
20 . . . Suction Hole
21 . . . Cavity
22 . . . Cavity Bottom Member
23 . . . Upper In-Loading Unit
24 . . . Lower In-Loading Unit
25 . . . In-Loading Connector
26 . . . Rack Standing Member
27 . . . Rotational Shaft
28 . . . Rotation Mechanism
29 . . . Bearing Unit
30 . . . Pinion Suspending Member
31 . . . Main Body of the Bearing Unit
32 . . . Slider
33 . . . Slider Hole
34 . . . Elastic Member
35 . . . Resin Compact
81 . . . Substrate Loading Unit
82 . . . Substrate Alignment Unit
83 . . . Resin Material Loading Unit
84 . . . Resin Material Distribution Unit
85 . . . Molded Product Placing Unit
86 . . . Molded Product Containing Unit
A . . . Molding Unit
B . . . In-Loading Unit
C . . . Out-Loading Unit
D . . . In-Loading Mechanism
E . . . Out-Loading Mechanism
F . . . In-Loading Mechanism Moving Area
G . . . Out-Loading Mechanism Moving Area
H . . . Unit Connector
J . . . Substrate Supply Mechanism Unit
K . . . Resin Material Supply Mechanism Unit

1. A compression molding method comprising the steps of:
a) individually supplying an insert member to each of two compression molding dies vertically arranged in a stacked fashion;
b) supplying an adequate amount of resin material to each of the two compression molding dies;
c) clamping each of the two compression molding dies; and
d) compression-molding, in each of the two compression molding dies, the insert member with the resin material to form a molded product.

2. A compression molding method comprising the steps of
a) individually supplying an insert member to an insert member setting unit provided in a top die of each of two compression molding dies vertically arranged in a stacked fashion each having the top die and a bottom die;
b) supplying an adequate amount of resin material to a compression molding cavity provided in the bottom die of each of the two compression molding dies and heating the resin material;
c) clamping the top die and the bottom die in each of the two compression molding dies; and
d) pressurizing the resin in the compression molding cavity in each of the two compression molding dies to compression-mold the insert member in the compression molding cavities.

3. The compression molding method according to claim 2, comprising the step of:
in clamping each of the two compression molding dies, moving the bottom die of the upper compression molding die by a distance of L and moving the bottom die of the lower compression molding die by a distance of 2L.

4. The compression molding method according to claim 2, comprising the step of
in clamping each of the two compression molding dies, clamping them while a distance between a die surface of the top die and a die surface of the bottom die is adjusted in each of the two compression molding dies in accordance with a thickness of the insert member supplied to each of the two compression molding dies.

5. The compression molding method according to claim 2, comprising the steps of
covering the compression molding cavity in each of the two compression molding dies with a mold release film; and
supplying the resin material to each cavity which is covered with the mold release film and heating the resin material.

6. A compression molding apparatus for compression-molding an insert member with a resin material, having a molding unit comprising:
a) a stacked molding unit in which two compression molding dies each having a top die and a bottom die are vertically arranged in a stacked fashion; and
b) a die opening/closing means for opening/closing the two compression molding dies.

7. A compression molding apparatus, having a molding unit comprising:
a) an upper compression molding die and a lower compression molding die each having a top die and a bottom die and each being for compression-molding an insert member with a resin material, the upper compression molding die and the lower compression molding die being vertically arranged in a stacked fashion;
b) an upper fixed platen for fixing the upper top die;
c) a lower fixed platen provided beneath the upper fixed platen;
d) an adequate number of columns for connecting the upper fixed platen and the lower fixed platen;
e) an intermediate plate provided between the upper bottom die and the lower top die while fixing both of them and vertically slidably mounted on one or more of the columns;
f) a slide plate vertically slidably mounted on one or more of the columns and for fixing the lower bottom die;
g) a die opening/closing means for individually closing a die surface of the top die and a die surface of the bottom die provided in each of the compression molding dies;
h) a pressure mechanism provided between the slide plate and the lower fixed platen, for applying a predetermined clamping pressure to the two compression molding dies from beneath the slide plate;
i) an insert member setting unit provided on each of the die surfaces of the top dies, on which the insert member can be supplied and set;
j) a compression molding cavity individually provided on the die surface of each of the bottom dies; and
k) a heater for heating the resin material supplied to the compression molding cavity.

8. The compression molding apparatus according to claim 6, comprising:
a) an in-loading unit for supplying the insert member and the resin material to each of the compression molding dies; and
b) an out-loading unit for taking out a molded product from each of the compression molding dies and the out-loading unit having a container for containing the molded product.

9. The compression molding apparatus according to claim 8, wherein each of the in-loading unit, the molding unit, and the out-loading unit is attachable and detachable among these three units.

10. The compression molding apparatus according to claim 6, including a plurality of molding units.

11. The compression molding apparatus according to claim 6, wherein;
the die opening/closing means comprises a die opening/closing mechanism having a rack and pinion mechanism composed of two racks and one pinion.

12. The compression molding apparatus according to claim 7, wherein the die opening/closing means has a die opening/closing mechanism which comprises:
a) a rack fixed to one of the columns;
b) an other rack fixed to a rack standing member vertically provided on the slide plate;
c) a pinion rotatably gear-engaged between the two racks;
d) a rotational shaft provided on the pinion;
e) a rotation mechanism for rotating the rotational shaft;
f) a bearing unit for rotatably supporting the rotational shaft; and
g) a pinion suspending member vertically suspended from the intermediate plate and having the bearing unit at a lower end thereof.

13. The compression molding apparatus according to claim 6, wherein the die opening/closing means has a thickness adjustment mechanism for adjusting a distance between the die surface of the top die and the die surface of the bottom die of each of the upper compression molding die and the lower compression molding die, in accordance with a thickness of the insert member supplied to each of the upper and lower compression molding dies.

14. The compression molding apparatus according to claim 12, wherein the die opening/closing means has a thickness adjustment mechanism which comprises:
a) a bearing unit main body fixed to the pinion suspending member to which the other rack is fixed;
b) a slider hole formed in the bearing unit main body;
c) a bearing unit slider which vertically and elastically slides in the slider hole and rotatably supports the rotational shaft of the pinion; and
d) an elastic member for vertically and elastically sliding the slider in the slider hole.

15. The molding apparatus according to claim 6, wherein:
each of the two bottom dies has a compression molding cavity having an inside covered with a mold release film.

16. The compression molding apparatus according to claim 7, comprising:
a) an in-loading unit for supplying the insert member and the resin material to each of the compression molding dies; and
b) an out-loading unit for taking out a molded product from each of the compression molding dies and the out-loading unit having a container for containing the molded product.

17. The compression molding apparatus according to claim 7, including a plurality of molding units.

18. The compression molding apparatus according to claim 7, wherein:
the die opening/closing means comprises a die opening/closing mechanism having a rack and pinion mechanism composed of two racks and one pinion.

19. The compression molding apparatus according to claim 7, wherein the die opening/closing means has a thickness adjustment mechanism for adjusting a distance between the die surface of the top die and the die surface of the bottom die of each of the upper compression molding die and the lower compression molding die, in accordance with a thickness of the insert member supplied to each of the upper and lower compression molding dies.

20. The molding apparatus according to claim 7, wherein:
each of the two bottom dies has a compression molding cavity having an inside covered with a mold release film.
